(19) United States
(12) Patent Application Publication
(10) Pub. No.: US 2005/0188956 A1
(43) Pub. Date: Sep. 1, 2005

(54) Dual Material Fuel Manifold For An Internal Combustion Engine With Direct Fuel Injection And Method For Its Production

(75) Inventors: Renzo Moschini, Bologna (IT); Filippo Maria Ielpo, Roma (IT)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: MAGNETI MARELLI POWERTRAIN S.P.A., Corbetta (IT)

(21) Appl. No.: 10/906,415

(22) Filed: Feb. 18, 2005

(30) Foreign Application Priority Data
Feb. 27, 2004 (IT) BO2004A 000114

(51) Int. Cl. F02M 1/00

(52) U.S. Cl. 123/456

(57) ABSTRACT

A fuel manifold for an internal combustion engine provided with a supply duct which is adapted to distribute the fuel under pressure to the injectors and is made by a first material, and a connection body which internally incorporates the supply duct, is adapted to enable the mechanical connection of the fuel manifold within the engine, is made by a second material different from the first material, and is made by moulding the second material in a mould containing the supply duct.

### TECHNICAL FIELD

The present invention relates to a fuel manifold for an internal combustion engine and to a method for its production.

The present invention is particularly advantageously used in the production of a fuel manifold for the direct injection of petrol into an internal combustion engine supplied with petrol to which the following description will make explicit reference without entering into superfluous detail.

### BACKGROUND ART

In recent years, petrol-supplied internal combustion engines in which the petrol is injected directly into the cylinders have come to the fore; in these engines, the petrol is supplied under pressure to a fuel manifold connected to a series of injectors (one for each cylinder of the engine), which are cyclically actuated to inject part of the petrol under pressure contained in the fuel manifold directly into the respective cylinders.

In known engines with indirect petrol injection, the pressure of the petrol in the fuel manifold is fairly low (generally between 2 and 4 atmospheres); in these known engines with indirect petrol injection the fuel manifolds are therefore currently made by plastics material (typically moulded technopolymers) and are secured to the intake manifold, also generally made by plastics material, by means of a series of screws, as plastics material is easy to process and extremely economic. However, in an engine with direct petrol injection, the pressure of the petrol in the fuel manifold is relatively high (currently between 100 and 200 atmospheres); a fuel manifold of plastics material does not have good mechanical properties and is not therefore able to withstand the relatively high petrol pressures typical of direct petrol injection with the necessary margins of safety.

In order to ensure the necessary mechanical strength, it has been chosen, in known engines with direct petrol injection, to use fuel manifolds made by steel; however, these fuel manifolds are costly because of the number of machining and welding operations to which they have to be subject, and, in addition, this solution makes it necessary to connect the steel fuel manifold to the air manifold by means of a connection flange which has to be machined separately, thereby increasing production costs even further.

It has been proposed to use a fuel manifold made by aluminum cast by gravity die casting; this fuel manifold is also decidedly costly, however, as gravity die casting is a relatively slow moulding method, requires a high number of machining operations once the component has been removed from the mould, and imposes minimum component thickness of no less than 4-5 mm. In order to try to reduce the machining costs of a fuel manifold made by cast aluminum, it has been proposed to make the fuel manifold from thixotropic aluminum using a pressure die casting method; however, experimental tests have shown that a fuel manifold made by aluminum does not always guarantee a satisfactory mechanical strength particularly when the pressure of the petrol in the fuel manifold is greater than 150 atmospheres. Moreover, a fuel manifold made by aluminum does not ensure sufficient resistance to the corrosion caused by some commercially available fuels (in particular fuels containing significant percentages of ethyl or methyl alcohol) and it is therefore necessary to coat the parts of the fuel manifold exposed to the petrol by anodic oxidation or by nickel-plating; however, these coating processes are complex and expensive and does not always manage to guarantee the necessary corrosion resistance particularly as, during normal operation of the engine, the temperature of the petrol in the fuel manifold is relatively high (and may even be above 100° C.).

JP9217661A discloses an intake manifold which is furnished with an intake manifold main body and a fuel rail integrally provided with it; the intake manifold main body has a plural number of branch pipes having intake ports and an arm part. The fuel rail is constituted of a cylindrical pipe material formed of a metallic pipe body and a metal cast made cast and inserted part to bury and hold the pipe material by casting and inserting an outer wall surface of the pipe maternal; the metallic pipe body constituting the pipe material is formed by rolling, and accordingly, it has favourable fuel permeation resistance.

GB2390116A discloses an intake manifold, fuel rail and moulded injector pack assembly for I.C. engines; moulded plastics injector packs each have airflow passages for communication with the intake manifold and fuel passages that receive the fuel injection valves and are sealed to the fuel rail by convoluted seals welded to an outer surface of each passage. The fuel rail, which may be made of steel, includes the injection valves; electronics packs, including valve actuating coils, are moulded into the injector packs and are connected to a supply terminal. Seals on the injector packs seal against the manifold and the engine block, respectively.

DE19953942A1 discloses a fuel feed system for an Injection IC engine and having a fuel pipe onto which are threaded one connector module for each fuel injector. The modules have an inner duct which connects from holes in the fuel pipe to a connecting flange which couples to each injector; the modules fit a variety of engines using fuel pipes cut to size and bored with distribution holes at the appropriate spacing. The modules can be die cast or metal/plastic moulded

### SUMMARY

An object of the present invention is to provide a fuel manifold for an internal combustion engine which is free from the drawbacks described above and which is, in particular, easy and economic to embody.

A further object of the present invention is to provide a method for the production of a fuel manifold for an internal combustion engine which is free from the drawbacks described above and which is, in particular, easy and economic to embody.

The present invention therefore relates to a fuel manifold for an internal combustion engine and to a method for its production as claimed in the attached claims.

### BRIEF DESCRIPTION OF THE DRAWINGS

Embodiments of the present invention will now be described with reference to the accompanying drawings, which show a number of non-limiting embodiments, wherein:

FIG. 1 is a diagrammatic view of an internal combustion engine with direct petrol injection provided with a fuel manifold of an embodiment of the present invention;

FIG. 2 is a perspective view of a possible embodiment of the fuel manifold of FIG. 1;

FIG. 3 is a front view of the fuel manifold of FIG. 2;

FIG. 4 is a perspective view of a supply duct of the fuel manifold of FIG. 1;

FIG. 5 is a view in cross-section along the line V-V of the fuel manifold of FIG. 2 coupled to a head of the engine of FIG. 1;

FIG. 6 is a perspective view of an alternative embodiment of the fuel manifold of FIG. 1;

FIG. 7 is a perspective view of a further embodiment of the fuel manifold of FIG. 1.

### DETAILED DESCRIPTION OF THE PREFERRED EMBODIMENTS

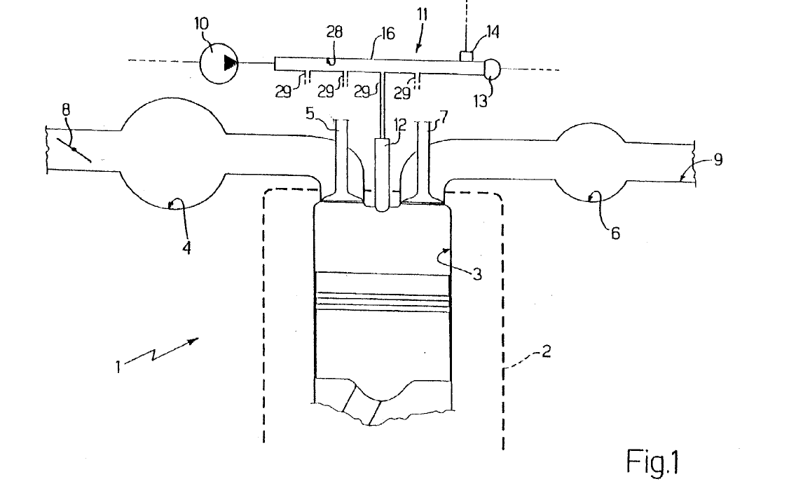

In FIG. 1, an internal combustion engine is shown overall by 1 and comprises a head 2 in which four cylinders 3 (only one of which is shown in FIG. 1) are provided, each of these cylinders being connected to an intake manifold 4 by means of at least one respective intake valve 5 and to an exhaust manifold 6 by means of at least one respective exhaust valve 7. The intake manifold 4 receives fresh air (i.e. air from the external environment) via a butterfly valve 8 which may be adjusted between a closed position and a position of maximum opening; an exhaust duct 9 leads from the exhaust manifold 6 and is provided with one or a plurality of catalysts (not shown in detail) for the discharge into the atmosphere of the gases generated by the combustion in the cylinders 3.

A low pressure pump (not shown in detail) supplies the petrol from a tank (not shown in detail) to a high pressure pump 10 which, in turn, supplies the petrol to a fuel manifold 11; the fuel manifold 11 is connected to a series of injectors 12 (one for each cylinder 3), each of which is cyclically actuated to inject part of the petrol under pressure contained in the fuel manifold 11 into the respective cylinder 3. The pressure value of the petrol in the fuel manifold 11 is kept equal, instant by instant, to a desired value by means of a pressure regulator 13 which is coupled to the fuel manifold 11 and is adapted to discharge any surplus petrol to a recycling duct which returns this surplus petrol upstream of the low pressure pump (not shown). The fuel manifold 11 is also connected to a sensor 14 adapted to measure the pressure value of the petrol contained in the fuel manifold 11.

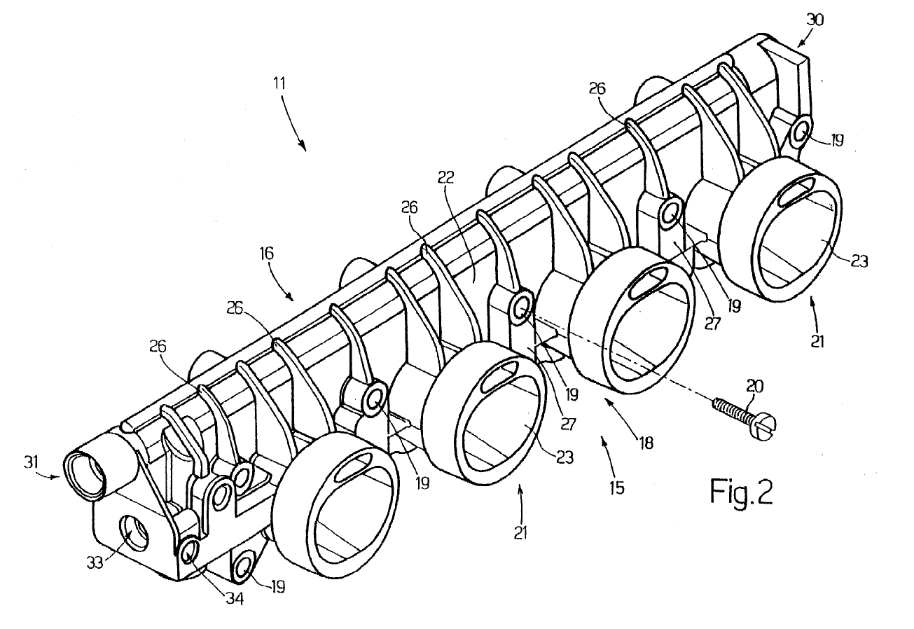

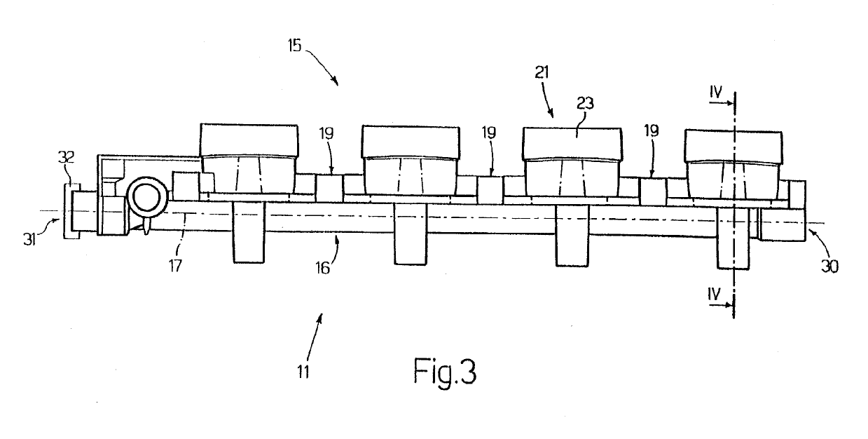

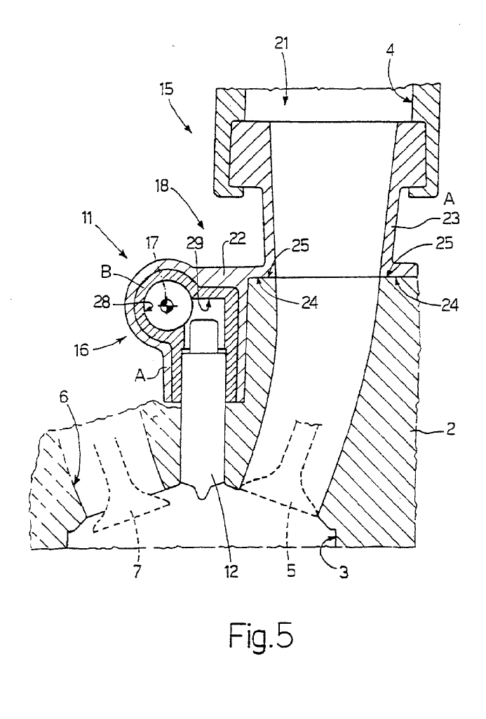

As shown in FIGS. 2 to 5, the fuel manifold 11 comprises a connection body 15 which is formed by a material A and is adapted to enable the mechanical connection of the fuel manifold 11 within the engine 1, and a supply duct 16 which is formed by a material B different from the material A, is incorporated within the connection body 15, has a substantially cylindrical shape with a central axis of symmetry 17 and is adapted to distribute the petrol under pressure to the injectors 12. In other words, the connection body completely or substantially completely internally incorporates the supply duct 16 in a non-removable manner.

It is important to note that mechanical resistance to the pressure of the petrol is generally the task solely of the supply duct 16; in other words, the supply duct 16 is dimensioned so that it is able alone to withstand the petrol pressure, although the presence of the connection body 15 covering the supply duct 16 increases the mechanical strength of this supply duct 16. However, in some cases the connection body 15 can also have a structural function for withstanding to the pressure of the fuel fed trough the supply duct 16; in other words, the supply duct 16 is not able alone to withstand the petrol pressure and the presence of the connection body 15 covering the supply duct 16 gives to the supply duct 16 the mechanical strength necessary to withstand the petrol pressure.

In a preferred embodiment, the material B is stainless steel having a thick of 2 mm and the material A is aluminum having a thickness of 3 mm. In this case, the supply duct 16 can be made by using a shearing, which is easy and economic to embody; it is important to note, that the shearing cannot be used when the thickness of the stainless steel element is greater than 2 mm. In other words, the mechanical contribution of the connection body 15 allows using a relatively thin supply duct 16 made by stainless steel, which can be made by using a shearing.

The connection body 15 in particular comprises a flange 18 which is disposed laterally to the supply duct 16, has a plurality of through holes 19 so that it can be secured by respective screws 20 to the head 2 of the engine 1 and comprises four coupling members, each of which is adapted to bring a respective cylinder 3 into communication with the intake manifold 4. The flange 18 comprises a substantially plane plate 22 which extends laterally to the supply duct 16 from a median portion of this supply duct 16; each coupling member 21 comprises a tubular body 23 which rises from the plate 22 in a perpendicular manner with respect to the plane in which the plate 22 lies. The upper end portion of each tubular body 23 is preferably shaped to facilitate connection with a respective duct leading from the intake manifold 4. A lower surface 24 of the plate 22, i.e. the opposite surface with respect to the tubular bodies 23, is plane and has a relatively very small surface roughness so as to be able to be coupled in a leak-tight manner (possibly with the interposition of a gasket) with a corresponding upper surface 25 of the head 2.

A series of reinforcing ribs 26 which concern both the plate 22 and the supply duct 16 are disposed in a perpendicular manner with respect to the plane in which the plate 22 lies and with respect to the axis 17 of the supply duct 16. The flange 18 comprises a series of raised zones 27, via each of which a respective through hole 19 is provided for the passage of a connection screw 20 with the head 2 of the engine 1. A part of the reinforcing ribs 26 starts from the raised zones 27, while the remaining part of the reinforcing ribs 26 starts from the tubular bodies 23.

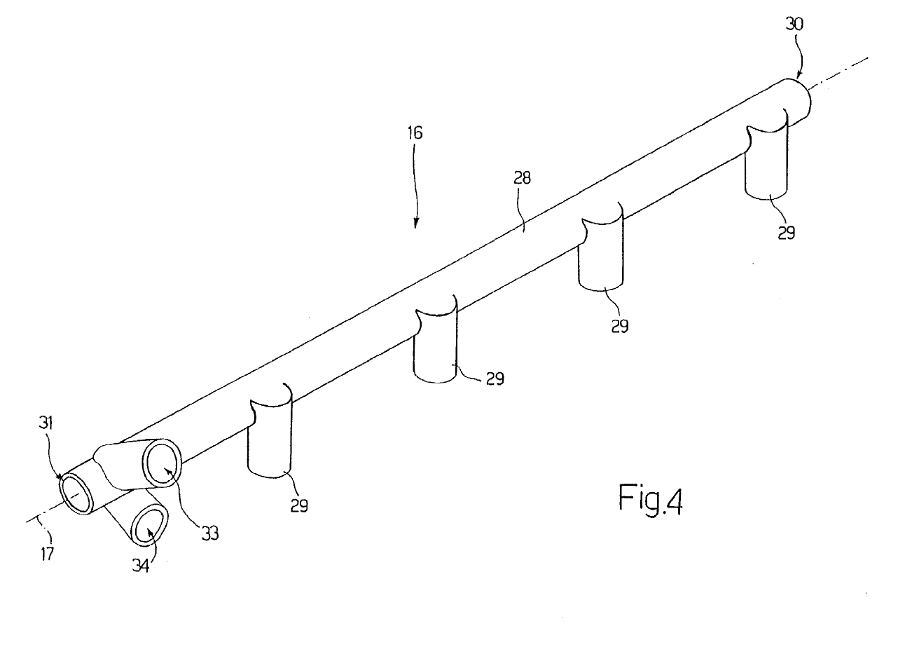

As shown in FIG. 4, the supply duct 16 is formed by a main cylindrical tubular channel 28 from which a series of further secondary cylindrical tubular channels 29 disposed perpendicular to the main cylindrical tubular channel 28 departs. Each secondary cylindrical tubular channel 29 is adapted to house a respective injector 12 in a leak-tight manner. The main cylindrical tubular channel 28 comprises two opposing open ends 30 and 31. The end 30 is connected to the high pressure pump 10 for the supply of the petrol under pressure to the fuel manifold 11, while the end 31 is closed by a relative screw cap 32. The purpose of the end 31 is to enable the main cylindrical tubular channel 28 to be correctly produced during the moulding process of the supply duct 16. In the vicinity of the end 31, the main cylindrical tubular channel 28 comprises an opening 33 adapted to receive the pressure regulator 13 and an opening 34 adapted to receive the pressure sensor 14.

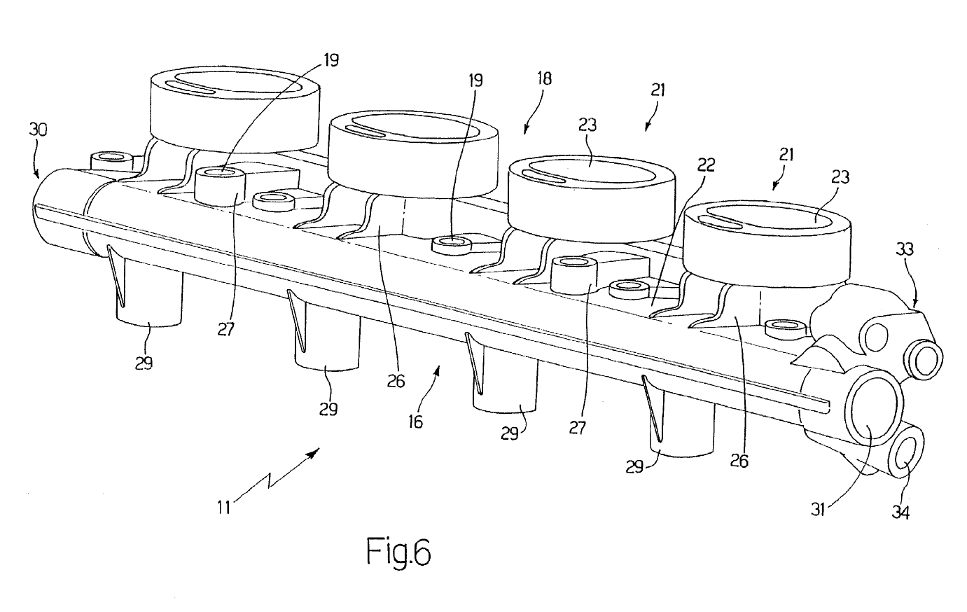

FIG. 6 shows an embodiment of the fuel manifold 11 which is slightly different from that shown in FIGS. 2 to 5. The differences between the two embodiments largely have to do with the shape of the connection body 15.

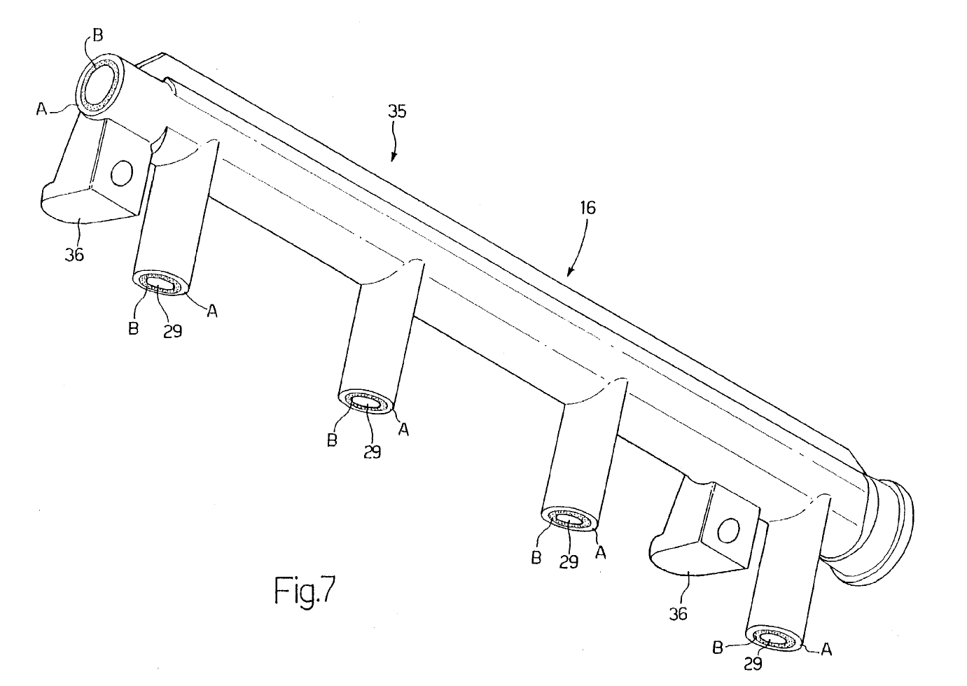

According to a different embodiment shown in FIG. 7, the connection body 15 comprises solely a tubular jacket 35 which encloses the supply duct 16 and a number of drilled brackets 36 each of which is disposed laterally with respect to the supply duct 16 and is adapted to be mechanically coupled to the head 2 by respective screws (not shown).

For the production of the fuel manifold 11, the supply duct 16 is made separately from the connection body 15 using the material B, the supply duct 16 is disposed in a mould (known and not shown) negatively reproducing the shape of the connection body 15, and the material A is supplied to the mould to form the connection body 15 about the supply duct 16. The material A is preferably supplied to the mould containing the supply duct 16 by a pressure die casting method, or by an injection method. The supply duct 16 may be made by welding the channels 29 to the channel 28 or by shaping a monolithic metal tube by hydroforming.

In this way, the supply duct 16 is substantially embedded in the connection body 15; in other words, the connection body 15 covers the supply duct 16 in a substantially complete manner.

The supply duct 16 is acted upon in use by a flow of pressurised petrol; for this reason, the material B forming the supply duct 16 is a material which has both a good mechanical strength and a good resistance to corrosion. The material forming the supply duct 16 is preferably stainless steel (for instance a stainless steel of the 300 series such as stainless steel 316); as an alternative, the material B forming the supply duct 16 could be a nickel alloy, if a corrosion resistance greater than that of stainless steel is required.

The connection body 15 is not in contact with the petrol and does not therefore have to be able to withstand the pressure of the petrol or the corrosion generated by the petrol; for that reason, the material A forming the connection body 15 is a material which is simple and economic to process. The material A forming the connection body 15 is preferably aluminum or thixotropic aluminum if a greater mechanical strength is required. As an alternative, the material A forming the connection body 15 is a plastics material either of the thermoplastic type, or of the thermosetting type; for instance, the material A forming the connection body 15 could be a technopolymer, ABS, nylon or an epoxy resin. The material A forming the connection body 15 could also be a metal material other than aluminum, for instance a nickel alloy. An important requirement for the material A is that it has a melting point lower than the material B so that the material A may be moulded in a mould containing the supply duct 16 made by the material B without causing damage to or deformations of this supply duct 16.

It will be appreciated from the above that the fuel manifold 11 comprises an inner jacket (the supply duct 16) and an outer skin (the connection body 15) with different functions, made by different materials and produced by means of two different production technologies. The inner part (the supply duct 16) made by the material B has the structural function of withstanding the petrol pressure and the corrosion caused by the petrol; the outer part (the connection body 15) made by the material B has the function of enabling the mechanical connection of the fuel manifold 11 within the engine 1. Differentiating the functions into two separate parts makes it possible separately to optimise the geometry, the material and the production process.

According to a further embodiment which is not shown, the supply duct 16 is formed by two or more different materials, and/or the connection body 15 is formed by two or more different materials.

Various experimental tests have shown that the fuel manifold 11 described above is particularly economic and simple to produce and at the same time manages to work completely safely with petrol supply pressures close to 300 bar; in particular, the fuel manifold 11 is particularly economic and simple to produce as the connection body 15 having a complex shape is made by the material A which is easy to process, while the supply duct 16, made by the material B which is more difficult to process, has a shape which is not complex. Moreover, the above-described fuel manifold 11 optimally resists corrosion generated by all the commercially available fuels and in particular by those fuels comprising significant percentages of ethyl or methyl alcohol; this result is directly due to the fact that all the parts of the fuel manifold 11 in contact with the petrol are made by the material B (typically stainless steel) which is particularly resistant to corrosion.

It will be appreciated that the fuel manifold described above may be advantageously used in an internal combustion engine supplied with fuels other than petrol, for instance an internal combustion engine supplied with LPG, methane, alcohol or diesel.

As a result of the many advantages described above, the constructional methods of the fuel manifold 11 may be applied to any component of an internal combustion engine which comprises a duct acted upon in use by a flow of fuel, and a connection body coupled to the duct and adapted to allow the mechanical connection of the component within the engine.

Although only preferred embodiments are specifically illustrated and described herein, it will be appreciated that many modifications and variations of the present invention are possible in light of the above teachings and within the purview of the appended claims without departing from the spirit and intended scope of the invention.

1. A fuel manifold for an internal combustion engine provided with a number of injectors; the fuel manifold comprising a supply duct which is adapted to distribute the fuel under pressure to the injectors and is made by a first material, and a connection body which is coupled to the supply duct and is adapted to enable the mechanical connection of the fuel manifold within the engine; wherein the connection body is made by a second material different from the first material, completely or substantially completely internally incorporates the supply duct in a non-removable manner, and is made by moulding the second material in a mould containing the supply duct.

2. A fuel manifold as claimed in claim 1, wherein the first material is a metal material.

3. A fuel manifold as claimed in claim 2, wherein the first material is stainless steel.

4. A fuel manifold as claimed in claim 2, wherein the first material is a nickel alloy.

5. A fuel manifold as claimed in claim 1, wherein the second material is a metal material.

6. A fuel manifold as claimed in claim 5, wherein the second material is aluminum.

7. A fuel manifold as claimed in claim 6, wherein the second material is thixotropic aluminum.

8. A fuel manifold as claimed in claim 5, wherein the second material is a nickel alloy.

9. A fuel manifold as claimed in claim 1, wherein the second material is a plastics material.

10. A fuel manifold as claimed in claim 9, wherein the second material is a thermoplastic plastics material.

11. A fuel manifold as claimed in claim 9, wherein the second material is a thermosetting plastics material.

12. A fuel manifold as claimed in claim 1, wherein the connection body s also made by a third material different from the first and the second material.

13. A fuel manifold as claimed in claim 1, wherein the second material is supplied to the mould containing the supply duct by means of a pressure die casting method.

14. A fuel manifold as claimed in claim 1, wherein the second material is supplied to the mould containing the supply duct by means of an injection method.

15. A fuel manifold as claimed in claim 1, wherein the engine comprises a head provided with a number of cylinders; the connection body comprising a number of brackets, each of which is disposed laterally with respect to the supply duct and is adapted to be mechanically coupled to the head.

16. A fuel manifold as claimed in claim 1, wherein the engine comprises a head provided with a number of cylinders, a number of injectors, each of which is connected to the fuel manifold and is adapted to inject the fuel directly into a respective cylinder, and an intake manifold which is connected to the head in order to supply fresh air to the cylinders; the connection body comprising a flange which is disposed laterally to the supply duct, comprises a plurality of through holes so that it can be secured by respective screws to the head of the engine and comprises a number of coupling members each of which is adapted to bring a respective cylinder into communication with the intake manifold.

17. A fuel manifold as claimed in claim 16, wherein the flange comprises a substantially plane plate which extends laterally to the supply duct from a median portion of this supply duct, each coupling member comprising a tubular body which rises from the plate perpendicular to the plane in which this plate lies.

18. A fuel manifold as claimed in claim 17, wherein a lower surface of the plate is plane and has a relatively very small surface roughness so that it can be coupled in a leak-tight manner with a corresponding upper surface of the head.

19. A fuel manifold as claimed in claim 17, wherein a series of reinforcing ribs are provided and are disposed perpendicular to the plane in which the plate lies and concern both the plate and the supply duct.

20. A fuel manifold as claimed in claim 19, wherein the flange comprises a series of raised zones, via each of which a respective through hole is provided for the passage of a connection screw with the head of the engine.

21. A fuel manifold as claimed in claim 20, wherein some reinforcing ribs start from the raised zones.

22. A fuel manifold as claimed in claim 19, wherein some reinforcing ribs start from the tubular bodies.

23. A fuel manifold as claimed in claim 1, wherein the supply duct is formed by a main cylindrical tubular channel, from which a series of further secondary cylindrical tubular channels departs, these channels being disposed perpendicular to the main cylindrical tubular channel; each secondary cylindrical tubular channel is adapted to house a respective injector in a leak-tight manner.

24. A fuel manifold as claimed in claim 23, wherein the main cylindrical tubular channel has two opposing open ends, one of which is used for the supply of the fuel under pressure, while the other is closed by a respective screw cap.

25. A fuel manifold as claimed in claim 24, wherein, in the vicinity of the end closed by the screw cap, the main cylindrical tubular channel comprises a first opening adapted to receive a pressure regulator and a second opening adapted to receive a pressure sensor.

26. A fuel manifold as claimed in claim 1, wherein the connection body has also a structural function for withstanding to the pressure of the fuel fed trough the supply duct.

27. A fuel manifold as claimed in claim 26, wherein the first material is stainless steel having a thickness of 2 mm and the second material is aluminum having a thickness of 3 mm.

28. A method for the production of the fuel manifold for an internal combustion engine as claimed in claim 1; the fuel manifold comprising a supply duct which is adapted to distribute the fuel under pressure to the injectors and is made by a first material, and a connection body which is coupled to the supply duct and is adapted to enable the mechanical connection of the fuel manifold within the engine; wherein the method comprises the stages of:
producing the supply duct separately from the connection body;
disposing the supply duct in a mould negatively reproducing the shape of the connection body; and
moulding the connection body about the supply duct by supplying a second material different from the first material to the mould.

29. A method as claimed in claim 28, wherein the first material is a metal material.

30. A method as claimed in claim 29, wherein the first material is stainless steel.

31. A method as claimed in claim 29, wherein the first material is a nickel alloy.

32. A method as claimed in claim 28, wherein the second material is a metal material.

33. A method as claimed in claim 32, wherein the second material is aluminum.

34. A method as claimed in claim 33, wherein the second material is thixotropic aluminum.

35. A method as claimed in claim 32, wherein the second material is a nickel alloy.

36. A method as claimed in claim 28, wherein the second material is a plastics material.

37. A method as claimed in claim 36, wherein the second material is a thermoplastic plastics material.

38. A method as claimed in claim 36, wherein the second material is a thermosetting plastics material.

39. A method as claimed in claim 28, wherein the connection body is also made by a third material different from the first and the second material.

40. A method as claimed in claim 28, wherein the second material is supplied to the mould containing the supply duct by means of a pressure die casting method.

41. A method as claimed in claim 28, wherein the second material is supplied to the mould containing the supply duct by means of an injection method.

42. A component of an internal combustion engine comprising a duct which is made by a first material and is acted upon in use by a flow of fuel, and a connection body which is coupled to the duct and is adapted to enable the mechanical connection of the component within the engine, wherein the connection body is made by a second material different from the first material, completely or substantially completely internally incorporates the duct in a non-removable manner, and is made by moulding the second material in a mould containing the supply duct.

43. A method for the production of the component as claimed in claim 42; the component comprising a duct which is made by a first material and is acted upon in use by a flow of fuel, and a connection body which is coupled to the duct and is adapted to enable the mechanical connection of the component within the engine; wherein the method comprises the stages of:
producing the duct separately from the connection body;
disposing the duct in a mould negatively reproducing the shape of the connection body; and
moulding the connection body about the duct by supplying a second material different from the first material to the mould.
